(19) United States
(12) Patent Application Publication
(10) Pub. No.: US 2010/0326226 A1
(43) Pub. Date: Dec. 30, 2010

(54) Auxiliary gear box adapted for use with the transmissions of off-road vehicles

(75) Inventor: Jeff Walston, Atascadero, CA (US)

Correspondence Address: LAW OFFICES OF ANDREW SCHROEDER, P.O. Box 6731, Santa Maria, CA, 93454, US

(73) Assignee: JEFF WALSTON

(21) Appl. No.: 12/459,097

(22) Filed: Jun. 26, 2009

(51) Int. Cl. F16H 59/04; F16H 57/02; F16H 57/08

(52) U.S. Cl. 74/473.36; 74/606 R; 475/331

(57) ABSTRACT

The Auxiliary Gear Box includes an Adapter Gear Housing, and a Transfer Case Adapter. The Adapter Gear Housing includes a Transmission Interface Surface, and a Posterior Surface. The Posterior Surface is in communication with the Transfer Case.

### FIELD OF THE INVENTION

The present invention is in the area of the mechanical arts, and more specifically refers to transmission parts used in off-road vehicles.

### BACKGROUND OF THE INVENTION

One of the more popular recreational activities for many people is off-road driving in various terrains. Most off-road driving is performed by owners of four-wheel drive vehicles. The reason why four-wheel drive vehicles are necessary in various terrains is to prevent the tires from getting stuck.

The problem with many off-road vehicles is that they are not specifically equipped for various terrains. Large rocks, boulders, hills, sand, mud, crevices, and other difficult obstacles can be dangerous for many 4-wheel drive vehicles to traverse because they may lack the necessary ratios to safely traverse those obstacles. Since many of these vehicles are predominantly designed for the highway, and smooth surface streets of the city, they lack the slow speed control to be effective off-road vehicles for all terrains.

Therefore, what is clearly needed in the art is an aftermarket assembly which can be quickly and easily incorporated into an off-road vehicle with 4-wheel drive. This extra gear box should give its user more gearing options to increase engine torque to suit the terrain which the vehicle is traversing. More gearing options aid the vehicle torque to move the tires with more precision, as well as enabling the vehicle with better traction in harsh off-road conditions such as sand, mud, crevices, etc. Furthermore, this implementation of an additional gear box should be able to be retrofitted without any drive shaft modifications to the vehicle. The extra bolt-in gear box should be able to simply replace the stock transmission tailhousing and should increase the transfer case gearing options from the stock two speeds to four speeds thereby aiding in the vehicles' off-road performance.

### SUMMARY OF THE INVENTION

It is an object of the present invention to provide an extra gearbox which can give a driver robust performance and heightened control of an off-road vehicle as it is being driven through various terrains. The present invention can add more throttle response, and control to the vehicle.

It is an object of the present invention to equip off-road vehicles with multiple gear ratios without having to perform any driveshaft modifications to the off-road vehicle. By providing a gearbox which can be retrofitted into an off-road vehicle without a driveshaft modification, the implementation of the gearbox is more affordable and easier to install and use.

It is an object of the present invention to provide a gear reduction assembly for use with off-road vehicles. By incorporating more gearing options, off-road drivers may be able to navigate their vehicles easier. This gear reduction provides increased control by reducing the speed of various off-road vehicles. The present invention does this by including lower gear ratios which are specifically designed to operate in off-road conditions. The added lower gear ratios are housed within an additional gear box. This gear box does not require any transmission output shaft modifications or transfer case modifications.

It is an object of the present invention to provide an after-market transmission assembly, which may be incorporated into the drive train of an off-road vehicle without any driveshaft modifications.

It is an object of the present invention to have power flow through the auxiliary gear box while in high range at essentially the same speed and torque.

### BRIEF DESCRIPTION OF THE DRAWING FIGURES

FIG. 1 is an elevated side view of a preferred embodiment of the present invention.

FIG. 2 is an elevated side view of a preferred embodiment of the present invention.

FIG. 3 is a plan view of a preferred embodiment of the present invention.

FIG. 4 is a plan view of a preferred embodiment of the present invention.

FIG. 5 is a perspective view of a preferred embodiment of the present invention.

FIG. 6 is an elevated side view of a preferred embodiment of the present invention.

FIG. 7 is a perspective view of a preferred embodiment of the present invention.

FIG. 8 is an exploded view of a preferred embodiment of the present invention.

FIG. 9 is an elevated side view of a preferred embodiment of the present invention.

FIG. 10 is an elevated side view of a preferred embodiment of the present invention.

FIG. 11 is an elevated side view of a preferred embodiment of the present invention.

FIG. 12 is an elevated side view of a preferred embodiment of the present invention.

FIG. 13 is an elevated side view of a preferred embodiment of the present invention.

FIG. 14 is an elevated side view of a preferred embodiment of the present invention.

FIG. 15 is an elevated side view of a preferred embodiment of the present invention.

FIG. 16 is a perspective view of a preferred embodiment of the present invention.

FIG. 17 is a perspective view of a preferred embodiment of the present invention.

### DESCRIPTION OF PREFERRED EMBODIMENTS

According to a preferred embodiment of the present invention, a unique Reduction Unit adapted for use with the Transmissions of Off-Road Vehicles is used to give a user greater control when driving in rugged terrain. The present invention is described in enabling detail below.

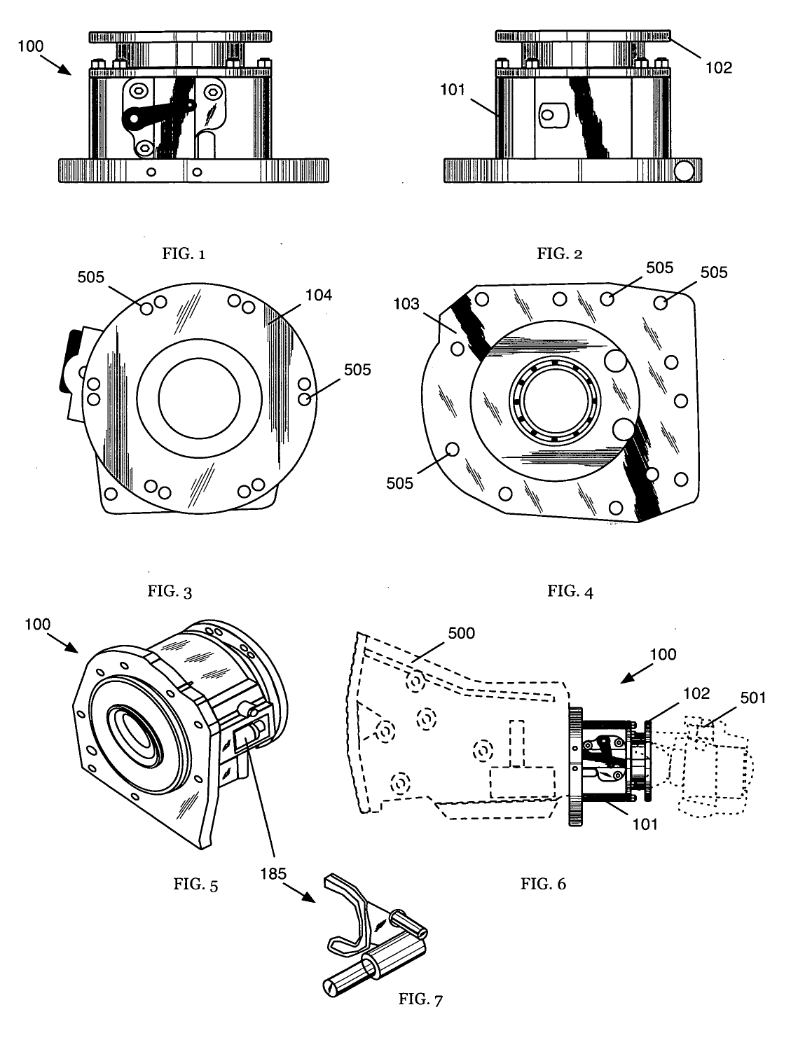

FIG. 1 illustrates a preferred embodiment of the present invention. The Auxiliary Gear Box 100 comprises an Adapter Gear Housing 101, and a Transfer Case Adapter 102. The Adapter Gear Housing 101 comprises a Transmission Interface Surface 103, and a Posterior Surface 102. The Posterior Surface 104 is in communication with the Transfer Case 501. FIG. 7 illustrates that in some preferred embodiments the Auxiliary Gear Box 100 may further comprise a Gearbox Shifting Assembly 185. The Gearbox Shifting Assembly 185 is affixed to the side of the Adapter Gear Housing 101 as illustrated in FIG. 5. The Gearbox Shifting Assembly 185 may employ either a cable, electric, hydraulic, or pneumatic.

In some preferred embodiments, the Adapter Gear Housing 101 may be comprised of an aluminum alloy which may be heat-treated. As illustrated in FIG. 6, the Auxiliary Gear Box 100 is bolted in between the Off-Road Vehicle Transmission 500 and the Transfer Case 501. FIG. 18 illustrates that the Auxiliary Gear Box 100 and the Output Shaft 109 replace the Stock Tailhousing 525 and the Stock Transmission Output Shaft 526.

FIG. 4 illustrates that the Transmission Interface Surface 105 comprises a plurality of bored holes 505 positioned and sized to mate with the Off-Road Vehicle Transmission 500. These bored holes 505 can enable a direct bolt-in between the Auxiliary Gear Box 100 and the Off-Road Vehicle Transmission 500. The Transfer Case Adapter 102 is in communication with the Posterior Surface 104 of the Adapter Gear Housing 101.

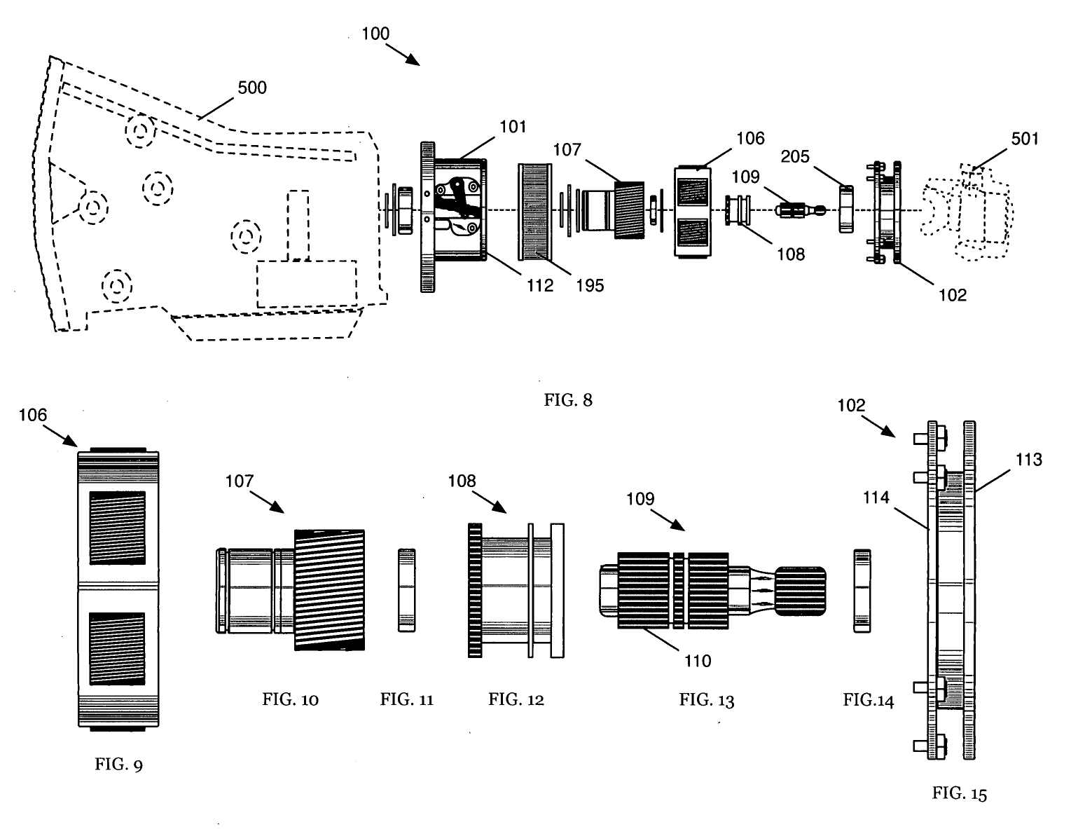

FIG. 8 illustrates that in some preferred embodiments the Auxiliary Gear Box 100 may further comprise a Planetary Assembly 106 and an Input Gear 107. The Input Gear 107 is splined to mate with the Output Shaft 109. The Planetary Assembly 106 is in communication with the annulus gear 195. In some preferred embodiments the Input Gear 107 may further incorporate a helical gear which is machined into the Input Gear 107 to match the standard planetary assembly. The Input Gear 107 is sized to mate with the transmission main output shaft. This coupling of the Input Gear 107 to the Off-Road Vehicle Transmission 500 can be made with no modifications to the Off-Road Vehicle Transmission 500. In some preferred embodiment, the Input Gear 107 is heat-treated and ground to fit a bearing that is installed into the Adapter Gear Housing 101.

The Planetary Assembly 106 and the annulus gear 195 provide the gear reduction for the Auxiliary Gear Box 100. The Planetary Assembly 106 comprises a plurality of planetary pinion gears. In some preferred embodiments the Planetary Assembly 106 may comprise three planetary gears. And in some preferred embodiments, the Planetary Assembly 106 may comprise six planetary gears. The Planetary Assembly 106 provides the gear reduction.

The Planetary Assembly 106 is in communication with the Input Gear 107 and is affixed to the Input Gear 107 with a snap ring. The Planetary Assembly 106 is in communication with the annulus gear 195. The annulus gear 195 is pressed into the Adapter Gear Housing 101. The annulus gear 195 is pressed before the housing is finished machined as to keep alignment of the Adapter Gear Housing 101 to the annulus gear 195.

In some preferred embodiments, the Planetary Assembly 106 has a gear ratio of 2.72:1 in the lower gear range. And in some preferred embodiments, the Planetary Assembly 106 has a 1:1 gear ratio when engaged in the higher ranges. However, it should be noted that the scope of the invention is not limited to a specific gear range. Therefore, the present invention may incorporate different gear ratios in different embodiments.

FIGS. 12-13 illustrates that in some preferred embodiments the Auxiliary Gear Box 100 may also include a shifter slider 108 and an Output Shaft 109. The Output Shaft 109 is affixed to the Transfer Case Adapter 102 and is installed with a first bearing 205. The Output Shaft 109 comprises a splined section 110. The splined section 110 of the Output Shaft 109 enables the shifter slider 108 to move freely to engage into a low gear ratio and into the direct gear ratio. The spline count on the splined section 110 of the Output Shaft 109 may vary in order to transmit power from the Auxiliary Gear Box 100 to the Transfer Case 501. In some preferred embodiments the spline count of the Output Shaft 109 is 23. The varying spline counts may depend upon the Transfer Case 501.

FIG. 8 illustrates that in some preferred embodiments the Auxiliary Gear Box 100 may further incorporate a Transfer Case Adapter 102. The Transfer Case Adapter 102 is in communication with the Posterior Surface 112 of the Adapter Gear Housing 101. The Transfer Case Adapter 102 is comprised of a First Lip 113 and a Second Lip 114. The First Lip 113 is in communication with a Transfer Case 501. The Transfer Case Adapter 102 supports a bearing that supports the Output Shaft 109. The Output Shaft 109 is affixed to the Transfer Case Adapter 102 with a retaining snap ring. The Transfer Case Adapter 102 is designed to bolt to the Transfer Case 501.

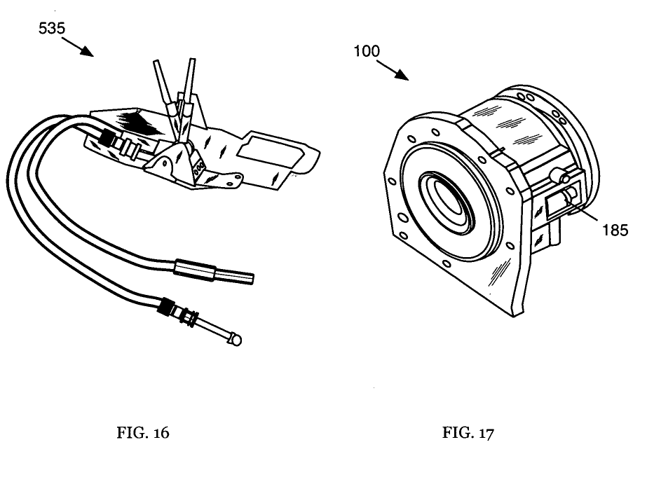

FIG. 16 illustrates a Universal Shifter Assembly 535 to be used in conjunction with the Auxiliary Gear Box 100. In some preferred embodiments, the Universal Shifter Assembly 535 is a twin stick cable shifter. This Universal Shifter Assembly 535 may employ a push-pull cable as its principal shifting mechanism. One line is in communication with the Universal Shifter Assembly 535 and the other line is in communication with the Transfer Case 501.

It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. A Auxiliary Gear Box comprising:
an Adapter Gear Housing, and a Transfer Case Adapter;
the Adapter Gear Housing comprises a Transmission Interface Surface, and a Posterior Surface;
the Transmission Interface Surface comprises a plurality of bored holes positioned and sized to mate with a Transmission;
the Transfer Case Adapter is in communication with the Posterior Surface of the Adapter Gear Housing.

2. The Auxiliary Gear Box of claim 1 further comprising a Planetary Assembly and an Input Gear; the Planetary Assembly comprises a plurality of planetary gears; the Input Gear is splined to mate with the Planetary Assembly.

3. The Auxiliary Gear Box of claim 2 wherein the Planetary Assembly comprises six planetary gears.

4. The Auxiliary Gear Box of claim 2 wherein the Planetary Assembly comprises three planetary gears.

5. The Auxiliary Gear Box of claim 2 wherein the Input Gear is a helical gear.

6. The Auxiliary Gear Box of claim 1 further comprising an Annulus Gear.

7. The Auxiliary Gear Box of claim 1 further comprising a Shifter Assembly; the Shifter Assembly is comprised of a shifter housing, and a shift fork.

8. The Auxiliary Gear Box of claim 1 further comprising a shifter slider and an Output Shaft; the Output Shaft comprises a splined section; the splined section of the Output Shaft enables the shifter slider to move freely to engage into a low gear ratio and into the direct gear ratio.

9. The Auxiliary Gear Box of claim 1 further comprising a Transfer Case Adapter Plate; the Transfer Case Adapter Plate is in communication with the Posterior Surface of the Adapter Gear Housing; the Transfer Case Adapter Plate is comprised of a First Lip and a Second Lip; the First Lip is in communication with a Transfer Case.
